(19) United States
(12) Patent Application Publication
(10) Pub. No.: US 2022/0129895 A1
(43) Pub. Date: Apr. 28, 2022

(54) SECURE TRANSACTION PROCESS UTILIZING INTEGRATION LAYER

(71) Applicant: Piggy LLC, Lake Mary, FL (US)

(72) Inventors: Nicholas Mahalec, Santa Monica, CA (US); John D. Anderson, Winter Springs, FL (US); Nicholas Corrieri, Sartell, MN (US); John Ginsberg, Southend-on-Sea (GB)

(21) Appl. No.: 17/512,567

(22) Filed: Oct. 27, 2021

Related U.S. Application Data
(60) Provisional application No. 63/106,755, filed on Oct. 28, 2020.

(51) Int. Cl. G06Q 20/40; G06Q 20/24

(52) U.S. Cl. CPC G06Q 20/401; G06Q 20/24

(57) ABSTRACT

An integration layer for securely completing transactions. The integration layer may receive, from an issuing server, transaction data for a pending purchase by a user, the transaction data including purchase data and payment card data. The transaction data may have been transmitted through an acquiring server, a payment card network (PCN), and an issuing server. Based on the transaction data, the integration layer may enroll the payment card in CLOs and provide BNPL options while the transaction is processing.

### CROSS REFERENCE TO RELATED APPLICATION

This application claims the benefit of U.S. Provisional Application No. 63/106,755, filed Oct. 28, 2020, entitled “SECURE TRANSACTION PROCESS UTILIZING INTEGRATION LAYER,” the content of which is incorporated by reference herein in its entirety.

### BACKGROUND

Billions of purchases are made each day and that number continues to increase. More frequently, these transactions are being completed with electronic forms of payment, rather than more traditional payment, such as cash or check. In some situations, additional incentives or options are also available for a customer looking to complete a purchase. These additional options, however, are difficult to identify and require significant time and effort on behalf of the user to register for such options. In addition, because the user has to search and register for such options, the opportunities for nefarious actors to steal a user's data may significantly increase. As just one example, during the COVID-19 pandemic, some security firms have reported a 30,000% increase of phishing attacks in 2020, with over 400,000 attempted attacks being reported each day. With the increased sophistication of malicious actors and phishing tools, users are significantly more likely to be subjected to such attacks and succumb to such attacks, especially when dealing with new or unfamiliar options for completing purchases. Transactions, such as purchases, are especially high targets for malicious actors, as those transactions directly involve the exchange of money and goods—the ultimate target for most malicious actors.

It is with respect to these and other general considerations that the aspects disclosed herein have been made. Also, although relatively specific problems may be discussed, it should be understood that the examples should not be limited to solving the specific problems identified in the background or elsewhere in this disclosure.

### SUMMARY

Examples of the present disclosure describe systems and methods for improving transaction technology. In an aspect, the technology relates to an integration server for securely completing a transaction. The integration server includes a processor; and memory storing instructions that, when executed by the processor, cause the integration server to perform a set of operations. The operations include receiving transaction data for a pending purchase by a user, the transaction data including payment card data and purchase data, wherein the payment card data was received by a terminal and the transaction data has been transmitted through an acquiring server, a payment card network (PCN), and an issuing server. The operations further include based on receiving the transaction data, determining that a card-linked offer (CLO) is available for the transaction data; transmitting a CLO prompt to at least one of the terminal or a user device; receiving a CLO response to the CLO prompt; and based on receiving the CLO prompt, transmitting a notification to enroll a payment card indicated in the payment card data in the CLO. The operations further include determining that the purchase data satisfies initial buy now, pay later (BNPL) criteria; based on the determination that the transaction data satisfies the initial BNPL criteria, identifying user data for the user; determining that the user data satisfies user BNPL criteria; based on determining that the user data satisfies the user BNPL criteria, transmitting anonymized transaction data to a plurality of BNPL servers, including a first BNPL server and a second BNPL server. In addition, the operations include receiving details for a plurality of BNPL options from the BNPL servers, including a first BNPL option from the first BNPL server and a second BNPL option from the second BNPL server; transmitting the details for the plurality of BNPL options to at least one of the terminal or the user device; receiving a selection of the first BNPL option; and transmitting a BNPL acceptance notification to the issuing server and the first BNPL server, wherein the acceptance notification indicates acceptance of the first BNPL option and the BNPL acceptance notification transmitted to the first BNPL server includes deanonymized user data.

In an example, the transaction data has been verified by the acquiring server and validated by the issuing server. In another example, the CLO prompt is transmitted to the user device via an Internet connection and does not pass through the PCN. In a further example, the CLO prompt is transmitted to the terminal via the issuing server, the PCN, and the acquiring server. In an additional example, the initial BNPL criteria includes a minimum purchase price. In yet another example, the user data is generated from interactions of the user with an integration app installed on the user device, wherein the integration app is managed by the integration server. In still another example, the user data includes at least one of historical transaction usage information, a rate of returning items, internet browsing history, or past rejected transactions. In still yet another example, the operations further include displaying the details for the plurality of BNPL options via the integration app.

In another aspect, the technology relates to a method for securely completing a transaction, the method performed by an integration layer. The method includes receiving transaction data for a pending purchase by a user, the transaction data including payment card data and purchase data, wherein transaction data has been transmitted through an acquiring server, a payment card network (PCN), and an issuing server; based on receiving the transaction data, determining that a card-linked offer (CLO) is available for the transaction data; and transmitting a notification to enroll a payment card indicated in the payment card data in the CLO. The method further includes identifying user data for the user, wherein the user data is generated from interactions of the user with an integration app installed on the user device, wherein the integration app is managed by the integration layer; determining that the user data satisfies user BNPL criteria; based on determining that the user data satisfies the user BNPL criteria, transmitting anonymized transaction data to one or more BNPL servers; receiving details for a plurality of BNPL options from the BNPL servers; based on the received details, accepting one of the BNPL option in the plurality of BNPL options; and transmitting a BNPL acceptance notification to the issuing server and one of the BNPL servers, wherein the acceptance notification indicates acceptance of the accepted BNPL option and the BNPL acceptance notification transmitted to the BNPL server includes deanonymized user data.

In an example, the transaction data has been verified by the acquiring server and validated by the issuing server. In another example, the payment card data was received by a terminal. In yet another example, the CLO prompt is transmitted to the user device via an Internet connection and does not pass through the PCN. In a further example, the method also includes displaying the CLO prompt via the integration app. In still another example, the CLO prompt is transmitted to the terminal via the issuing server, the PCN, and the acquiring server. In still yet another example, the user data includes at least one of historical transaction usage information, a rate of returning items, internet browsing history, or past rejected transactions.

In another aspect, the technology relates to a system comprising a terminal configured to read payment card data from a physical payment card, the terminal in communication with an acquiring server that is in communication with a payment card network (PCN); and an integration server in communication with a plurality of BNPL servers and an issuing server that is in communication with the PCN. The integration server includes a processor; and memory storing instructions that, when executed by the processor, cause the integration server to perform a set of operations. The set operations include receiving, from the issuing server, transaction data for a pending purchase by a user, the transaction data including purchase data and payment card data from a physical payment card read by the terminal, wherein the transaction data has been transmitted through an acquiring server, a payment card network (PCN), and an issuing server. The operations also include transmitting anonymized transaction data to the plurality of BNPL servers, including a first BNPL server and a second BNPL server; receiving details for a plurality of BNPL options from the BNPL servers, including a first BNPL option from the first BNPL server and a second BNPL option from the second BNPL server; transmitting the details for the plurality of BNPL options to the terminal for display on the terminal; receiving, from the terminal, a selection of the first BNPL option; and transmitting a BNPL acceptance notification to the issuing server and the first BNPL server, wherein the acceptance notification indicates acceptance of the first BNPL option and the BNPL acceptance notification transmitted to the first BNPL server includes deanonymized user data.

In an example, the details for the plurality of BNPL options are transmitted to the terminal via the issuing server, the PCN, and the acquiring server. In another example, the selection of the first BNPL option is received from the terminal via the acquiring server, the PCN, and the issuing server. In a further example, the operations also include identifying user data for the user; and determining that the user data satisfies user BNPL criteria. In yet another example, the user data is generated from interactions of the user with an integration app installed on a user device, wherein the integration app is managed by the integration server.

In another aspect, the technology relates to a method for securely completing a transaction, the method performed by an integration layer. The method includes receiving transaction data for a pending purchase by a user, the transaction data including payment card data and purchase data, wherein transaction data has been transmitted through an acquiring server; based on receiving the transaction data, determining that a card-linked offer (CLO) is available for the transaction data; and transmitting a notification to enroll a payment card indicated in the payment card data in the CLO. The method also includes identifying user data for the user, wherein the user data is generated from interactions of the user with an integration app installed on the user device, wherein the integration app is managed by the integration layer; determining that the user data satisfies user BNPL criteria; based on determining that the user data satisfies the user BNPL criteria, transmitting anonymized transaction data to a BNPL server; receiving details for a BNPL option from the BNPL server; based on the received details, automatically accepting the BNPL option; and transmitting a BNPL acceptance notification to an issuing server and one of the BNPL servers, wherein the acceptance notification indicates acceptance of the accepted BNPL option.

In another aspect, the technology relates to a computer-implemented method for securely completing a transaction. The method includes receiving transaction data for a pending purchase by a user, the transaction data including payment card data and purchase data, wherein transaction data has been transmitted through an acquiring server; identifying user data for the user; determining that the user data satisfies user BNPL criteria; based on determining that the user data satisfies the user BNPL criteria, transmitting at least a portion of the transaction data to a BNPL server; receiving details for a BNPL option from the BNPL server; based on the received details, automatically accepting the BNPL option; and transmitting a BNPL acceptance notification to an issuing server and one of the BNPL servers, wherein the acceptance notification indicates acceptance of the accepted BNPL option.

In another aspect, the technology relates to a computer-implemented method for securely completing a transaction. The method includes detecting an identification number for a payment card entered into an online payment field for an online purchase; determining that the payment card is unregistered with an integration layer; based on determining that the payment card is unregistered, generating a prompt to register the payment card; receiving a response to the prompt and registering the payment card with the integration layer; generating a CLO prompt for one or more CLOs; receiving a CLO response to the CLO prompt; and based on receiving the CLO prompt, transmitting a notification to enroll a payment card indicated in the payment card data in the CLO.

In an example, the method further includes receiving transaction data for the online purchase, the transaction data including payment card data and purchase data, wherein transaction data has been transmitted through an acquiring server, a payment card network (PCN), and an issuing server; identifying user data for the user; determining that the user data satisfies user BNPL criteria; based on determining that the user data satisfies the user BNPL criteria, transmitting anonymized transaction data to one or more BNPL servers; receiving details for a plurality of BNPL options from the BNPL servers; based on the received details, accepting one of the BNPL option in the plurality of BNPL options; and transmitting a BNPL acceptance notification to the issuing server and one of the BNPL servers, wherein the acceptance notification indicates acceptance of the accepted BNPL option and the BNPL acceptance notification transmitted to the BNPL server includes deanonymized user data. In another example, detecting the payment card identification is performed by a browser extension of a user device. In yet another example, the user device is a mobile device, a laptop, a tablet, or a desktop computer. In still another example, the CLO prompt is displayed via the browser extension.

In another aspect, the technology relates to a computer-implemented method for securely completing a transaction. The method includes detecting an identification number for a payment card entered into an online payment field for an online purchase; determining that the payment card is registered with an integration layer; based on determining that the payment card is registered, determining that a time duration since the last CLO registration event exceeds a time threshold; based on the determination that the time duration exceeds the time threshold, generating a CLO prompt for one or more CLOs; receiving a CLO response to the CLO prompt; and based on receiving the CLO prompt, transmitting a notification to enroll a payment card indicated in the payment card data in the CLO.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Additional aspects, features, and/or advantages of examples will be set forth in part in the description which follows and, in part, will be apparent from the description, or may be learned by practice of the disclosure.

### BRIEF DESCRIPTION OF THE DRAWINGS

Non-limiting and non-exhaustive examples are described with reference to the following figures.

FIG. 1 depicts an example system for securely completing a transaction.

FIG. 2A depicts an example terminal.

FIG. 2B depicts an example user device.

FIG. 2C depicts an example server.

FIG. 3 depicts an example communication diagram for securely completing a transaction.

FIGS. 4A-4C depict an example method securely completing a transaction.

FIG. 5 depicts another example method for securely completing a transaction.

### DETAILED DESCRIPTION

As discussed above, a significant increase in phishing attacks has recently occurred. Transactions, such as purchases, are ripe targets for attack. A phishing attack is an attack that attempts to steal a user's information or data. For instance, a malicious actor may present an imitation electronic form for a user to enter personal or financial data. When the form is completed and submitted, the data is transmitted to the malicious actor, unbeknownst to the user. These types of attacks are often easiest to perform when a user is registering for a new product or service, or when the user receives an unexpected request. With respect to transactions, a user may search for incentives or additional options to complete their transaction. When such searching of the Internet is unguided, a user may increase their likelihood of encountering a falsified website that is associated with a phishing attack. In addition, the more options or incentives for which the user separately registers, the more data that is provided by the user that could be potentially intercepted or be subject to a breach. In many situations, the user registers for multiple incentives or options, but only ends up utilizing one to complete a transaction, which renders the remaining registrations unnecessary and a potential source of avoidable risk.

To reduce the risk and exposure to phishing attacks, among other things, the present technology incorporates additional security into a purchase or transaction process by integrating the technology into a secure credit card or payment card purchasing architecture and process. The processes of the present technology may be triggered by the initiation of a purchase by the user with a credit card or payment card. For instance, upon the payment card being provided to the merchant, such as via a merchant terminal, the payment card data and purchase details are transmitted to an acquiring server that performs an initial authentication and security protocol on the transaction. These strict security protocols may include those set forth in the Payment Card Industry Data Security Standard among others. The acquiring server transmits the data to a payment card network, which may perform additional verification processes. The payment card network then transmits the data to the issuing server of the institution that issued the payment card utilized at the terminal. The issuing server may perform additional authentication and validation processes for the transaction. Upon the issuing server verifying the transaction data, the issuing server provides the authenticated, verified transaction data to the integration layer of the present technology.

Upon receiving the authenticated, verified transaction data from the issuing server, the integration layer utilizes such data to automatically identify incentives and options for completing the transaction. The integration layer may then automatically enroll the user into the incentives and options for completing the transaction. In some examples, different options and/or details of those options may be presented to the user for selection. Those options and/or details may be presented directly through the merchant terminal and/or a user device. Because these options are triggered based on the authenticated, verified data and prompted during the transaction, the user expects the prompts and can be more confident that the options presented are legitimate. The user also limits the data they provide to those option(s) which are optimal or useful in the present transaction, thus no longer needlessly providing data for options that are not necessary or relevant. The integration layer may then facilitate completion of the transaction with the selected options, as detailed further below. The integration of options and incentives and completion of the transaction may all be processed within a matter of seconds, which may occur while the user is standing at the merchant terminal or completing an online transaction.

One newer option that may be utilized or applied by the present technology is a “buy now, pay later” (BNPL) option. BNPL is an option to purchase the current product now but pay for the product over a series of payments or installments. Afterpay and Klarna are two examples of BNPL entities or providers, but the number of providers is continuing to grow. This new type of provider is unfamiliar to many users and the BNPL entities themselves may not yet be well-known to users. Accordingly, a user may be more likely to unintentionally provide information to a fraudulent source. The present technology may verify the BNPL entities utilized to prevent fraudulent information from being provided to the user. In addition, the present technology may also filter BNPL sources based on the transaction data, the user data, and the BNPL terms such that only BNPL sources that are possible for the user and the transaction are presented to the user, which further reduces unnecessary entry of personal details by the user. The BNPL sources may also be filtered based on the terms for completing the transaction, such as interest or payment intervals. Accordingly, the user is also provided with the BNPL source that provides the lowest cost for completing the transaction. In some cases, by using a BNPL rather than a traditional credit card to complete the transaction, the user may eliminate or significantly reduce the interest charged for almost all transactions.

Another incentive or option that may utilized or applied by the present technology is a card linked offer (CLO) option. A CLO is generally a cashback, point, miles, etc. incentive for certain purchases that may be tied to a particular payment card. For instance, a CLO may exist for a merchant or brand of item, and if that item is purchased with a linked payment card, a portion of the purchase price is automatically refunded to the user. The refund may be provided as a statement credit, a payment, or other form. The present technology may automatically enroll a user for a CLO for the transaction that is currently being processed while the transaction is being processed. Accordingly, the user need not search or register for the CLO prior to the transaction being started.

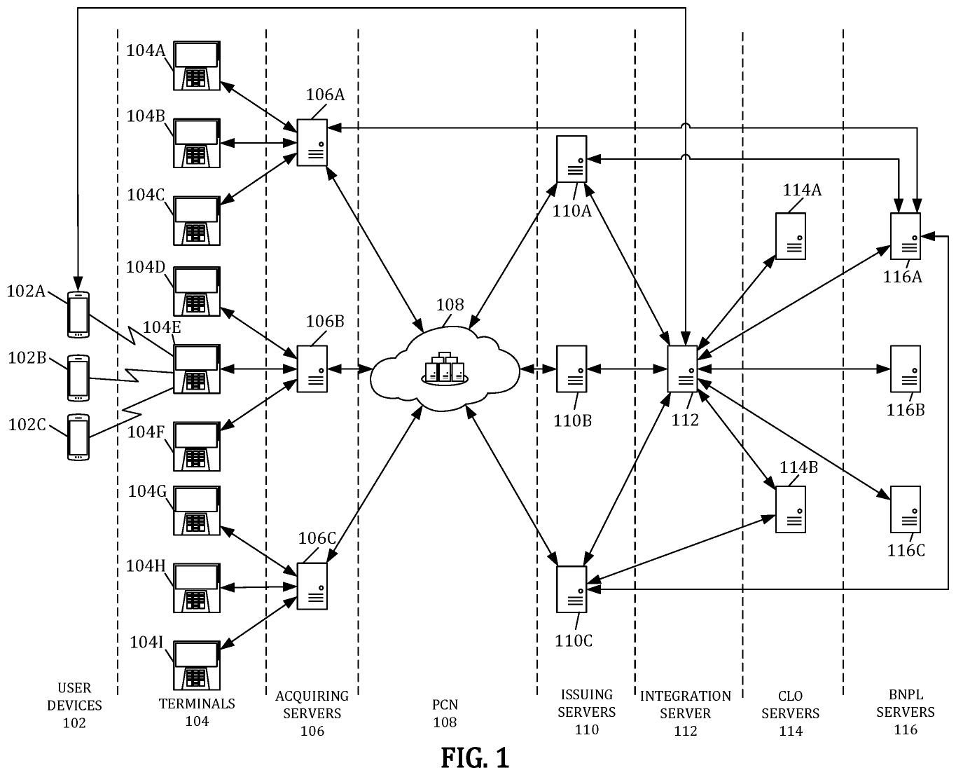

FIG. 1 depicts an example system 100 for securely completing a transaction. The system 100 includes a plurality of terminals 104, such as terminals 104A-I. Each of the terminals 104 may be located within a store or merchant. For instance, a particular merchant may have one or more terminals 104. The terminal 104 may be configured to receive a physical payment card, such as a credit card or debit card. For example, the terminals 104 may include a magnetic reader for reading a magnetic strip of the payment card and/or a chip reader for reading a chip of the payment card. The terminals 104 may also include a radio-frequency identification (RFID) reader or transceiver, or other near-field communication technology, for reading an RFID tag of a payment card. The RFID technology of the terminals 104 may also be configured to receive payment details from user devices 102.

The user devices 102, such as user devices 102A-C, may be smartphones, tablets, laptops, desktops, or other similar devices of users that enter a merchant to complete a purchase. The user devices 102 may store payment information, such as credit card numbers and/or virtual payment cards (VPCs). The credit card numbers and/or VPCs may be transmitted from the user devices 102 to the terminals 104. For example, a user having user device 102A may enter a store of a merchant that houses terminal 104E. Once the user collects one or more items for purchase and proceeds to the checkout, the user may open a virtual wallet app on the user device 102A and select a VPC stored in the virtual wallet. The user then brings the user device 102A into proximity of the terminal 104E. The user device 102A transmits the VPC information to the terminal 104E. In other examples, the user may utilize a physical payment card and swipe or insert the physical payment card into the terminal 104E.

The terminals 104 transmit the payment card information received from a user device 102 or from a physical card, along with other details about the transaction, to one or more acquiring servers 106. The transaction data transmitted from the from a terminal 104 to an acquiring server 106 may include the payment card information, amount for the transaction, items or types of items for the transaction, a merchant or merchant type where the transaction is taking place, and/or geographical location of the terminal 104, among other data. The terminals 104 may include communication technologies, such as cellular data and/or wireless Internet (e.g., Wi-Fi), built into the terminals 104 themselves to facilitate communication between the terminals 104 and the acquiring servers 106. In other examples, the terminals 104 may be operatively connected to Internet communication technology located within the store of the merchant, such as routers, modems, etc.

In other examples, the user may be performing an online transaction via the user device. The payment card data may be provided to the merchant via a web site or application rather than a physical terminal in a store. In such examples, the merchant may still transmit the transaction data for the pending purchase to the acquiring servers 106.

The acquiring servers 106 are servers that are operated by an acquiring bank or institution. The acquiring institution may be a bank of the merchant. As an example, a first acquiring institution may operate the first acquiring server 106A, a second acquiring institution may operate the second acquiring server 106B, and a third acquiring institution may operate the third acquiring server 106C. The acquiring servers 106 may perform security transaction processes on the received transaction details to help ensure transaction security. For instance, the acquiring servers 106 may authenticate the transaction data received from the terminals 104 and perform other operations according to the Payment Card Industry Data Security Standard. The acquiring servers 106 may also manage the transfer of funds to and from the merchant. The authenticated transaction data is then transmitted by the acquiring servers 106 to the payment card network (PCN) 108.

The PCN 108 may be operated by one or more entities that process card payments, such as Visa, MasterCard, or other similar entities. For instance, if the payment card is a Visa card, the PCN 108 may be VisaNet. The PCN 108 may perform additional authentication or security operations on the transaction data and forward the data to the issuing servers 110.

The issuing servers 110 may be servers operating by entities that issued the payment card utilized to purchase the goods (e.g., the card entered into the terminal 104). As an example, a first issuing institution may operate the first issuing server 110A, a second issuing institution may operate the second issuing server 110B, and a third issuing institution may operate the third issuing server 110C. The issuing servers 110 may perform additional verification operations on the received transaction data and perform operations to either approve or deny the transaction. A particular issuing server 110, such as issuing server 110A, issuing server 110B, or issuing server 110C, may be operated by the bank of the user. If an issuing server 110 approves a transaction or purchase based on the transaction details, the issuing server 110 initiates a transfer of funds from the issuing bank to the acquiring bank, and transmits a notification back through the PCN 108, the acquiring servers 106, and ultimately to the terminal 104 to indicate the transaction has been approved. With the present technology, the issuing servers 110 are in communication with an integration layer, such as integration server 112, that can augment the transaction process and provide additional details for approving and completing the transaction. Accordingly, prior to issuing an approval or denial transmission, the issuing servers transmit the authenticated, verified transaction details to an integration server 112.

The integration server 112 processes the received transaction details to implement additional incentives and purchase options for completing the transaction, as discussed further herein. The integration server 112 may also be in communication with CLO servers 114 and BNPL servers 116. The CLO servers 114 control the CLOs and can apply the offers to the transaction. The BNPL servers 116 are operated by different BNPL entities. The BNPL servers 116 generate BNPL offers for the transaction and ultimately control collection of funds from a user that is enrolled in a BNPL option or plan. In some examples, the issuing servers 110 may also be in communication with the CLO servers 114. In such examples, the transaction data may be first transmitted from the issuing servers 110 to the CLO servers 114, which may then transmit the transaction data to the integration server 112.

The integration server 112 may also be in communication with one or more of the user devices 102. For instance, the integration server 112 may be able to communication with the user devices via an Internet connection that does not pass through the issuing servers 110, the PCN 108, and/or the acquiring servers 106. Accordingly, the integration server 112 may communicate with the user directly via a user device 102 or indirectly through the issuing servers 110, the PCN 108, the acquiring servers 106, and/or the terminals 104. In some examples, the user devices 102 may have an integration app operated by the integration server 112 installed on the user devices 102. Communication between the integration server 112 and the user may occur via the installed integration app. The devices and servers within the system 100 may communicate with one another via application programming interfaces (APIs).

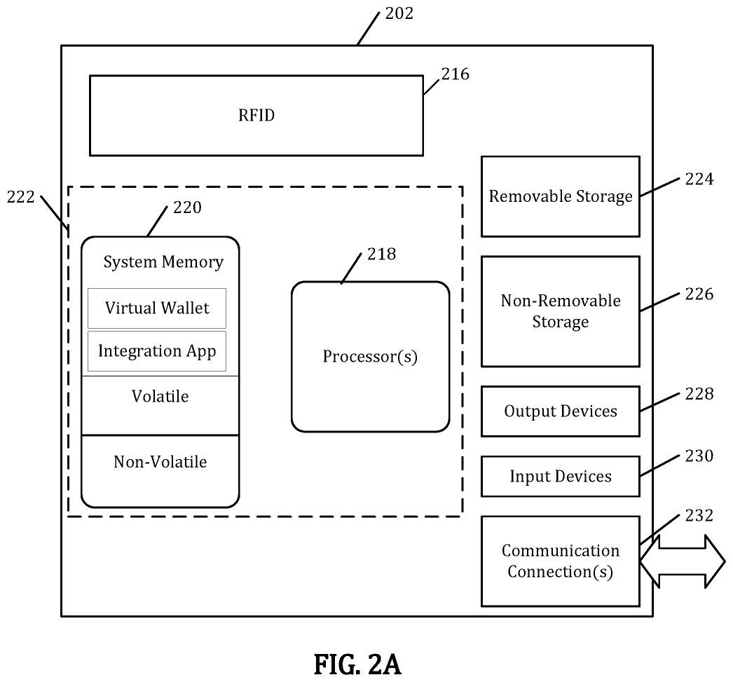

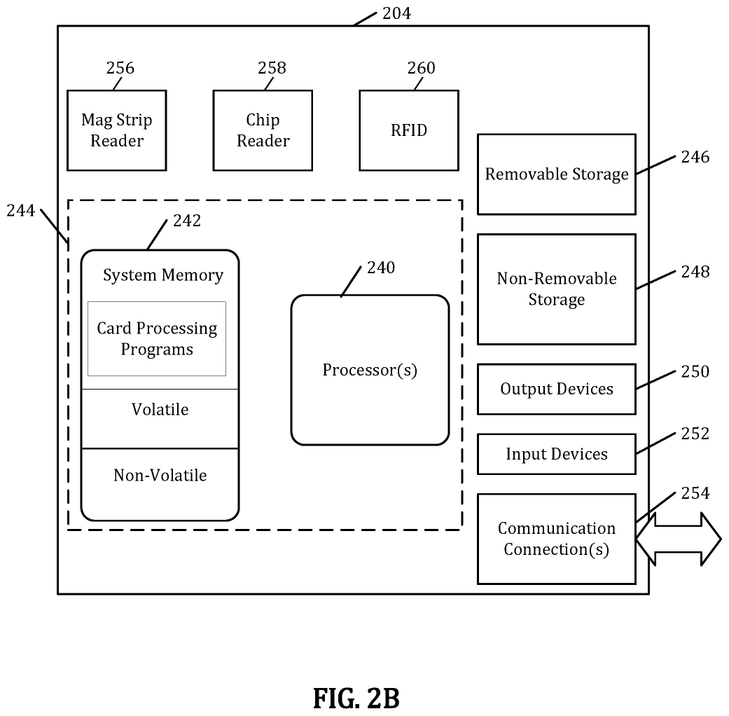

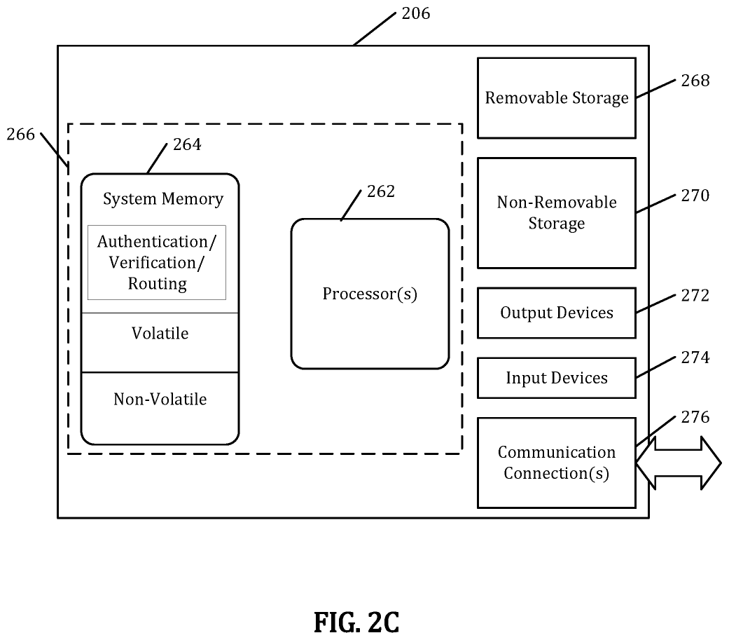

FIG. 2A depicts an example user device 202. The user device includes computing components 222. In a basic configuration, the computing components 222 typically include at least one processor 218 and memory 220. Depending on the exact configuration, memory 220 can be volatile (such as RAM), non-volatile (such as ROM, flash memory, etc.), or some combination of the two. Further, the user device 202 may also include storage devices (removable 224, and/or non-removable 226) including, but not limited to, solid-state devices, magnetic or optical disks, or tape. The memory may store, among other things, a virtual wallet storing payment card data and an integration app operated by the integration layer or server. Further, the user device 202 may also have input device(s) 230 such as a touch screen, keyboard, mouse, pen, voice input, etc., and/or output device(s) 228 such as a display, speakers, printer, etc. One or more communication connections 232, such as a local-area network (LAN), wide-area network (WAN), point-to-point, Bluetooth, RF, etc., may also be incorporated into the user device 202. The user device 202 may also include RFID technology 216, such as an RFID transceiver. The RFID technology 216 is able to communicate the payment card information from the virtual wallet to other devices in close proximity, such as a terminal.

FIG. 2B depicts an example terminal 204. The example terminal 204 may include many of the same type of components as the user device 202. For instance, the terminal 204 may include computing components 244. The computing components 244 include at least one processor 240 and memory 242. Depending on the exact configuration, memory 242 (storing, among other things, card processing programs and instructions to perform the operations disclosed herein) can be volatile (such as RAM), non-volatile (such as ROM, flash memory, etc.), or some combination of the two. Further, the terminal 204 may also include storage devices (removable 246, and/or non-removable 248) including, but not limited to, solid-state devices, magnetic or optical disks, or tape. Further, the terminal 204 may also have input device(s) 252 such as a touch screen, keyboard, mouse, pen, voice input, etc., and/or output device(s) 250 such as a display, speakers, printer, etc. One or more communication connections 254, such as a local-area network (LAN), wide-area network (WAN), point-to-point, Bluetooth, RF, etc., may also be incorporated into the terminal 204. The terminal 204 may also include a magnetic strip reader 256 to read a magnetic strip of a physical payment card, and a chip reader to read a chip of a physical payment card. The terminal 204 may also include an RFID technology 260, such as an RFID reader or transceiver. The RFID technology 260 is configured to receive payment card data from an RFID tag on a physical payment card or from a user device.

FIG. 2C depicts an example server 206. The example server 206 may include many of the same type of components as the user device 202. For instance, the server 206 may include computing components 266. The computing components 266 include at least one processor 262 and memory 264. Depending on the exact configuration, memory 264 (storing, among other things, authentication, verification, and/or routing programs and instructions to perform the operations disclosed herein) can be volatile (such as RAM), non-volatile (such as ROM, flash memory, etc.), or some combination of the two. Further, the server 206 may also include storage devices (removable 268, and/or non-removable 270) including, but not limited to, solid-state devices, magnetic or optical disks, or tape. Further, the server 206 may also have input device(s) 274 such as a touch screen, keyboard, mouse, pen, voice input, etc., and/or output device(s) 272 such as a display, speakers, printer, etc. One or more communication connections 276, such as a local-area network (LAN), wide-area network (WAN), point-to-point, Bluetooth, RF, etc., may also be incorporated into the terminal 204.

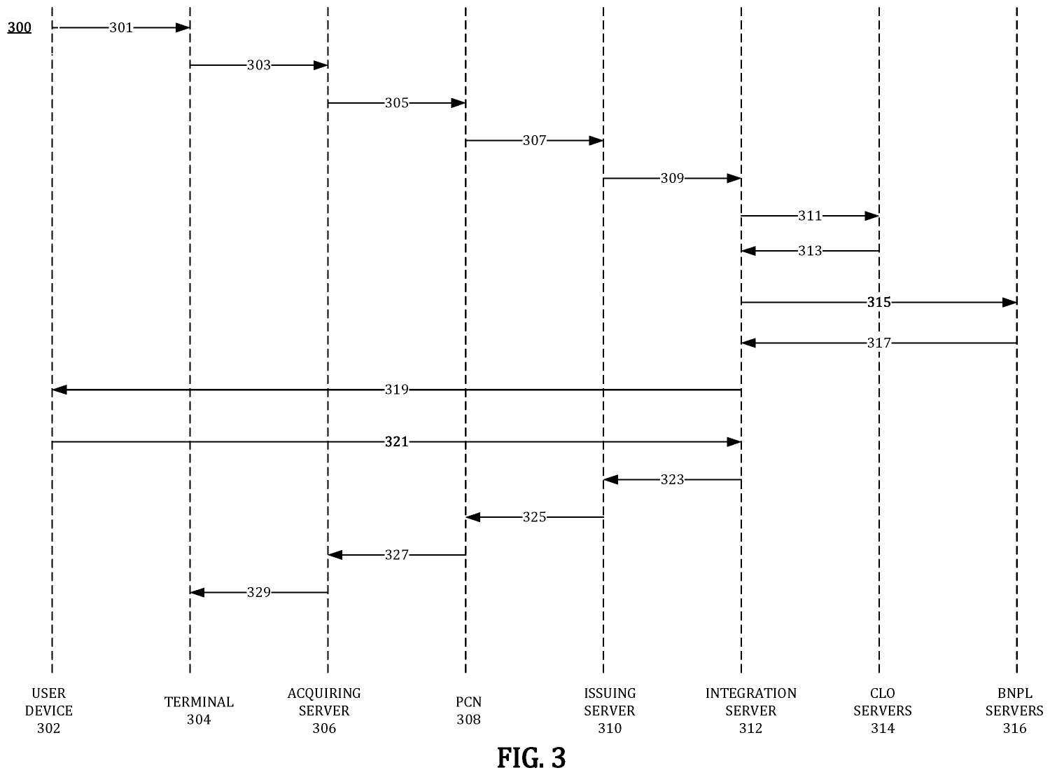

FIG. 3 depicts an example communication diagram 300 for securely completing an example transaction. In the example communication diagram 300, a user device 302 first transmits payment card data 301 to a terminal 304. The payment card data 301 may include the unique identification number for the payment card to be used (e.g., primary account number (PAN)), the name on the payment card, the expiration date, and/or the payment card security number (e.g., card security code (CSC), card verification data (CVD), card verification number, card verification value (CVV), card verification value code, card verification code (CVC), verification code (V-code or V code), or signature panel code (SPC), or the like). The user device 302 may transmit the payment card data 301 to the terminal 304 via RFID or other near-field technology. The terminal 304 augments the payment card data with additional data regarding the purchase (purchase data) that is attempting to be made, such as an amount for the purchase, items or types of items for the purchase, a merchant or merchant type where the purchase is taking place, and/or geographical location of the terminal 104, among other data. The combination of the purchase data and the payment card data may be referred to herein as the transaction data.

The acquiring server 306 then transmits the transaction data 303 to an acquiring server 306. The acquiring server 306 may be operated by a bank of the merchant that is operating the terminal 304. Accordingly, the acquiring server 306 may manage the transfer of funds to and from the merchant. The acquiring server 306 authenticates the received transaction data and may perform other security operations on the received transaction data.

The acquiring server 306 transmits the authenticated transaction data 305 to a PCN 308. The PCN 308 to which the authenticated transaction data 305 is transmitted may be selected based on the payment card information in the transaction data. For instance, if the payment card data indicates that the payment card is a Visa payment card, the payment card network 308 may be the VisaNet PCN 308.

The PCN 308 then transmits the authenticated transaction data 307 to an issuing server 310. The issuing server 310 may be operated by the institution that issued the payment card used for the purchase. Accordingly, the particular issuing server 310 to which the transaction data is to be forwarded may be identified based on the payment card data in the transaction data. The issuing server 310 may perform additional verification, authentication, and/or security operations on the received transaction data to help ensure that the transaction data is not fraudulent. If the issuing server 310 determines that the transaction data is likely fraudulent, the issuing server may immediately deny the purchase. If the issuing server 310 is able to validate the authenticated transaction data, the issuing server 310 transmits the authenticated, verified transaction data 309 to the integration server 312. In some examples, portions of the transaction data may be removed or anonymized by the issuing server 310 prior to being transmitted to the integration server 312.

While the integration server 312 is depicted as being a separate server from the issuing server 310, in some examples, the functionality of the integration server may be incorporated into the issuing server 310, the PCN 308, or another server. For instance, the functionality of the integration server 312 may be controlled by integration programming stored in the issuing server 310. In such examples, the issuing server 310 may transmit the authenticated, verified transaction data to the integration programming of the issuing server 310. Accordingly, as used herein, the term integration layer may encompass an integration server 312 or programming within the PCN 308 or another server, such as the issuing server 310.

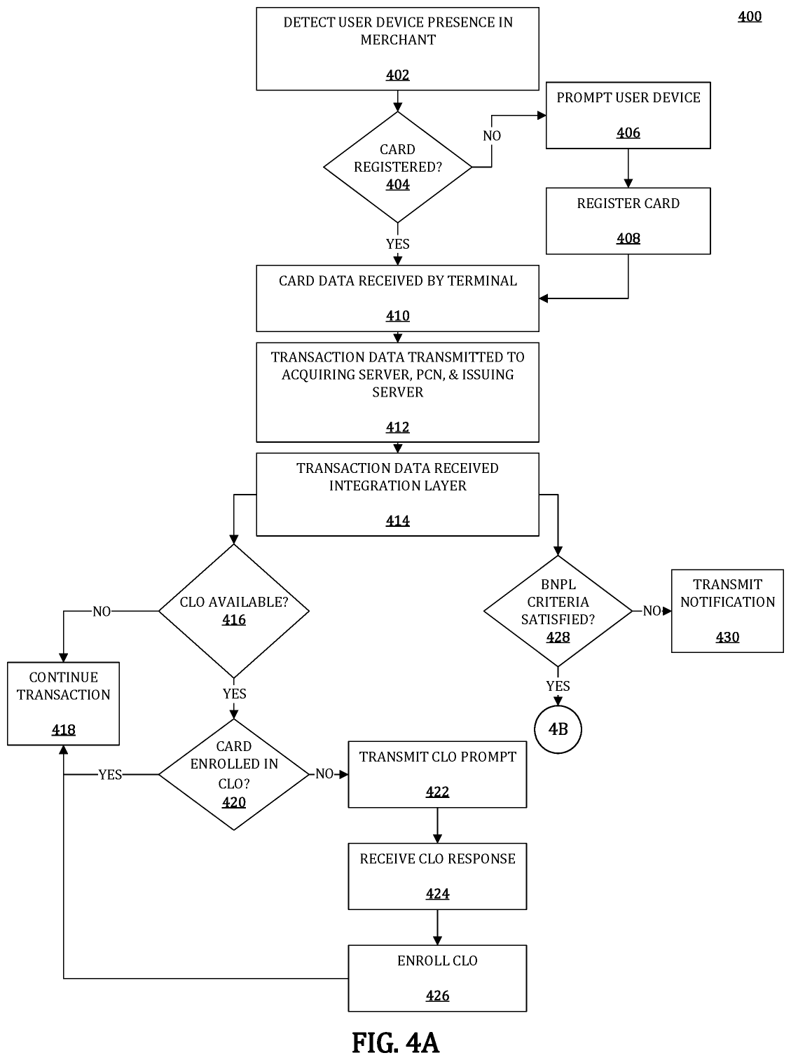

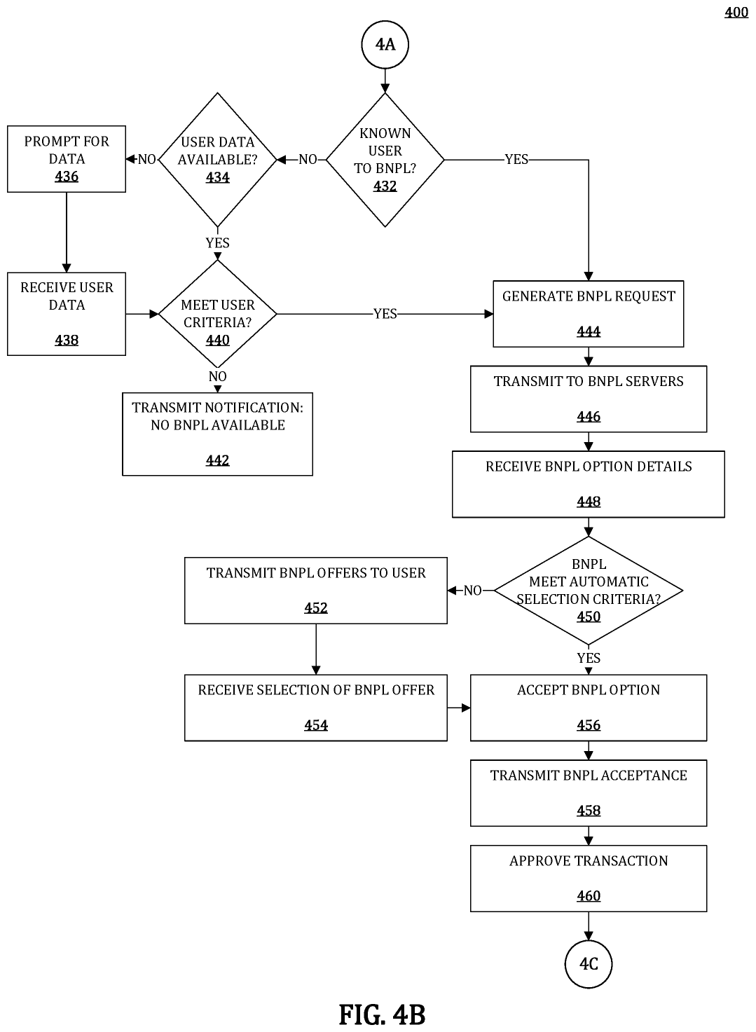

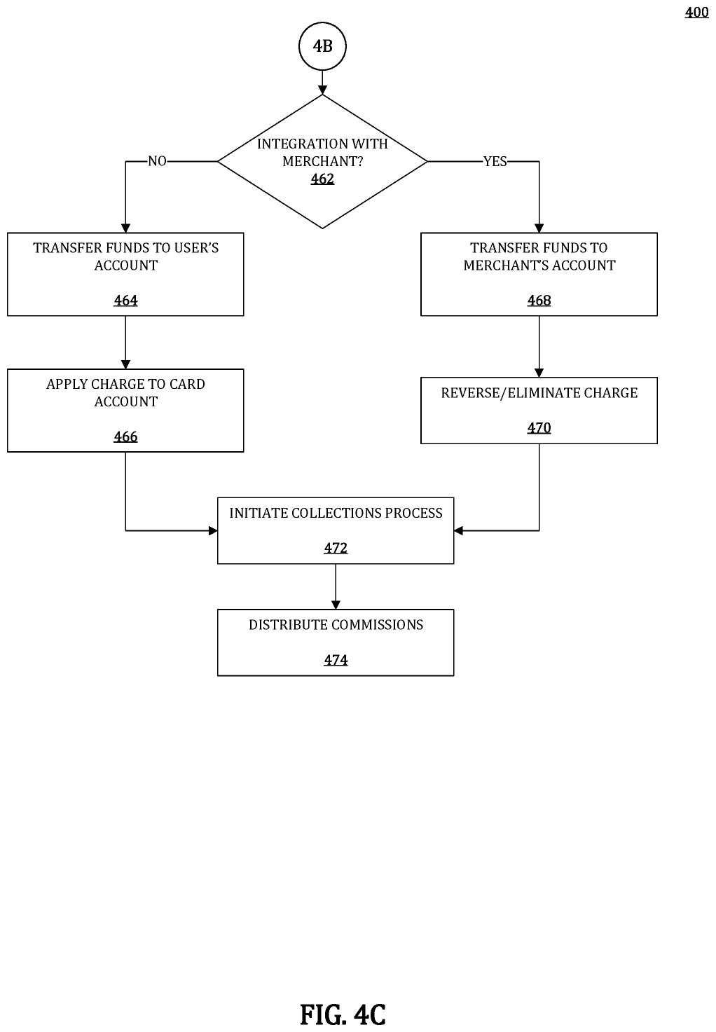

The integration server 312 may perform a series of operations on the received authenticated, verified transaction data 309, as discussed further herein and below with reference to FIGS. 4A-4C. For instance, integration server 312 may determine if there is a CLO for the merchant or product that is being purchased. The integration server 312 may make such a determination based on the merchant data and product data in the received transaction data. The integration server 312 may also identify which CLO entity, and a corresponding CLO server 314, from which the CLO is available. If there is a CLO, the integration server 312 may determine whether the payment card attempting the purchase has been enrolled in a CLO for the particular merchant or product that is being purchased. The integration server 312 may make such a determination by querying one or more CLO servers 314. If the payment card is not enrolled in the available CLO, the integration server 312 transmits a request 311 to the identified CLO server 314 to enroll the payment card in the identified CLO. The CLO server 314 processes the request, enrolls the payment card in the CLO, and transmits a confirmation to the integration server 312. In other examples, the CLO server 314 may require a confirmation from the user. In such examples, the integration server 312 may request a confirmation from the user by sending a prompt or request (not depicted) to the user device 302.

The integration server 312 may also analyze the received transaction data to determine whether the purchase may be eligible for a BNPL option for completing the transaction. If the integration server 312 determines that the purchase may qualify for a BNPL option, the integration server 312 prepares a request for BNPL options and transmits the BNPL request 315 to one or more BNPL servers 316. The BNPL request 315 may include transaction details and additional details regarding the user. Each of the BNPL servers 316 that receive the BNPL request 315 generate a response to the request and transmit that BNPL response 317 back to the integration server. The BNPL response 317 may include the terms of the BNPL option (e.g., interest rate, number of installments, etc.) for each BNPL entity.

The integration server 312 then transmits the received BNPL options 319 directly to the user device 302 for display at the user device 302. The user may then consider the provided BNPL options transmitted to the user device 302 and the user may select a particular BNPL option from the list of BNPL options. The user device 302 directly transmits the selected BNPL option to the integration server 312. The integration server 312 may communicate the BNPL server 316 to indicate the selected BNPL option. The integration server 312 also transmits a BNPL approval indication 323 to the issuing server 310. Based on receiving the BNPL approval indication 323, the issuing server 310 approves the transaction and transmits the transaction approval 325 to the PCN 308. The PCN 308 transmits the approval 327 to the acquiring server 306 and the acquiring server 306 transmits the approval to the terminal 304 where the purchase is ultimately completed.

The communication diagram 300 depicts one example transaction. Other, different transactions may occur according to the present technology. For instance, in some examples, the integration server 312 may automatically select a BNPL option where the terms of the BNPL meet user-selected or predefined criteria (such as a zero-percent interest rate). In other examples, the BNPL options may be communicated through the PCN 308 and the acquiring server 306 to the terminal 304 where the BNPL options are displayed to the user for selection. Accordingly, in such examples, a user device would not be necessary other than to provide the payment card information to the terminal. Where a physical payment card is utilized, no user device 302 may be necessary at all. In addition, while the example transaction in FIG. 3 is for an in-person purchase at a physical store of a merchant, the present technology may also be applied to online transactions. In online examples, the terminal is a payment server that received payment card details that have been input by the user on a user device or other computer. The data that would have been transmitted to, and displayed on, the terminal may then be displayed on the user device 302 or other terminal. For instance, the integration server 312 may operate a browser extension, and data such as BNPL offers may be displayed via the browser extension. In yet further examples, the user may be performing a purchase on a computer such as a laptop and the data from the integration server 312 may be transmitted to the user device 302, such as a smartphone. Accordingly, by using a second device of the user, a form of multi-factor authentication provides another layer of security in performing the transaction.

FIGS. 4A-C depict an example method 400 for securely completing a transaction. At operation 402, a user device presence in a store of a merchant may be detected. The presence of the user device may be detected by a Wi-Fi or Bluetooth beacon of the user device being detected by a router or other communication device within a store of the merchant. If the merchant has registered with the integration layer, a computing device of the merchant may transmit a notification to the integration layer that a user device has been detected within the store. The integration layer may then determine whether the user device has been previously registered with the integration layer, such as by installing an app managed by the integration layer (referred to as an integration app) on the user device. If the user device is not known to or registered with the integration layer, the merchant may transmit a prompt to the user device to install the integration app (if the merchant has an app installed on the user device). The user may then install the integration app on the user device.

If the integration app is installed on the user device, the integration layer may determine, at operation 404, if the user of the user device has registered any payment cards with the integration layer. The determination in operation 404 may also include receiving payment card information that is stored within a virtual wallet of the user device. For example, the virtual wallet may communicate information regarding stored payment cards to the integration app. If there are payment cards registered with the integration layer, method 400 flows to operation 410, where payment card data is received by a terminal of the merchant. Payment card data may be received by the terminal in the form of a virtual payment card transmitted by the user device or by a physical card swiped through, tapped on, inserted into, or otherwise detected by the terminal.

If, at operation 404, a determination is made that no card, or less than all cards within a virtual wallet of the user device, are registered with the integration layer, method 400 flows to operation 406, where a user is prompted to register one or more payment cards with the integration layer. The user may then enter payment card information into the integration app. In some examples, the user may select virtual payment cards from the virtual wallet to have the selected cards registered with the integration layer via the integration app. At operation 408, the payment card(s) entered by the user are registered with the integration layer. Registering the payment card(s) with the integration layer may also include the integration layer indicating to one or more issuing servers that the payment card(s) have been registered. For example, for each payment card registered, the integration layer may determine the issuing institution that issued the payment card. The integration layer may then notify the issuing server of the identified issuing institution that the payment card has been registered with the integration layer. When a purchase is attempted with the registered payment card, the issuing server transmits the transaction details to the integration layer. Accordingly, transaction data is transmitted from the issuing server to the integration layer only for registered payment cards. Once the payment card or cards have been registered, the method 400 flows to operation 410, which is performed as discussed above.

The payment card data that is received by the terminal in operation 410 may include the unique identification number for the payment card to be used (e.g., PAN), the name on the payment card, the expiration date, and/or the payment card security number (e.g., CSC, CVD, card verification number, CVV, card verification value code, CVC, V-code or V code, or SPC, or the like). To form transaction data, the terminal augments the payment card data with additional data regarding the purchase that is attempting to be made. Such purchase data may include an amount for the purchase, items or types of items for the purchase, a merchant or merchant type where the purchase is taking place, and/or geographical location of the terminal, among other data. In other examples where the transaction is an online transaction, the payment data is received by an online payment system that may perform the same functions as the terminal, such as augmenting the payment card data with purchase data to generate transaction data.

At operation 412, the transaction data is transmitted to the acquiring server, PCN, and the issuing server. For instance, as discussed above, the transaction data may be transmitted to the acquiring server, which authenticates the transaction data, among other things. The authenticated transaction data is then transmitted to the PCN for the particular payment card, which then routes the authenticated transaction data to an issuing server of the issuing institution that issued the payment card. The issuing server may further validate the transaction data to help prevent potential fraud. The transaction data may be transmitted directly to the integration layer by the issuing server or the issuing server may transmit the transaction data to a CLO server. The issuing server or CLO server may then provide the transaction data to the integration layer.

At operation 414, the authenticated, verified transaction data is received by the integration layer. The authenticated, verified transaction data may be received from the issuing server or the CLO server, as discussed above. The integration layer may then concurrently perform multiple operations based on the transaction data, such as enrolling the payment card in CLOs and generated BNPL options. Because these operations may be performed in a short time period (e.g., during the purchasing process), performing as many operations concurrently, or quickly in sequence, as possible may be beneficial in completing the method 400 within a short time period, such as less than 60 seconds or 120 seconds.

At operation 416, a determination is made as to whether any CLOs for the merchant and/or products being purchased are available. The determination may be made by querying one or more CLO servers to determine whether one or more CLOs are available for the merchant and/or products being purchased. In other examples, the integration layer may have a database of currently available CLOs and their corresponding CLO servers. If there are no CLOs available, the method 400 flows to operation 418 where the transaction continues.

If, however, a determination is made in operation 416 that one or more CLOs are available for the merchant and/or products within the transaction data, method 400 flows to operation 420, where a determination is made as to whether the payment card in the received transaction data is enrolled in the identified CLOs. If the payment card is already enrolled in all the identified CLOs for the pending purchase, the method 400 flows to operation 418 where the transaction continues. In some examples, operation 418 may also include notifying the issuing server that the payment card is, or has been, enrolled in one or more CLOs.

If, at operation 420, a determination is made that the payment card is not enrolled in all the identified CLOs for the pending purchase, the method flows to operation 422, where a CLO prompt is generated and transmitted. The CLO prompt is a prompt that is to be displayed to the user with the CLOs for which the payment card may be enrolled. The CLO prompt may be transmitted for display on the user device and/or the terminal. Where the CLO prompt is transmitted for display on the terminal, the CLO prompt may be transmitted back through the issuing server, the PCN, and/or the acquiring server. Where the CLO prompt is transmitted to the user device, the CLO prompt may be delivered via the Internet (i.e., not through the PCN) and displayed by the integration app installed on the user device.

At operation 424, a CLO response is received. The CLO response may be received from the user device and/or the terminal, depending on where the CLO prompt is displayed. Where the CLO response is received from the terminal, the CLO response may be first transmitted through the acquiring server, the PCN, and the issuing server. Where the CLO response is received from the user device, the CLO response may be received via an Internet connection and may not be transmitted through the PCN. If the CLO response is an affirmative response to enroll the payment card in the identified CLO(s), the payment card is enrolled in the identified CLO(s) at operation 426. Enrolling the payment card in the identified CLOs may include transmitting an indication of the affirmative response to the CLO server(s) that are providing the identified CLO(s). The respective CLO server(s) may then perform the enrollment of the payment card in the identified CLO(s). The CLO server(s) may also send a confirmation back to the integration layer that indicates the enrollment has completed. The method 400 then proceeds to operation 418, where the transaction continues.

Operation 418 may also include adjusting the transaction data according to the enrolled CLOs. For example, the CLOs are often effectively discounts on the purchase price of the products being purchased in the form of a cash back offer. Thus, the transaction data may be altered to reflect the discount or the presence of the CLO. The presence of the enrolled CLO and the resultant cost for purchasing the product(s) may affect whether the transaction qualifies for BNPL options and/or the terms of the provided BNPL options, as discussed further below.

BNPL-related operations may also be performed concurrently with, or subsequently to, the CLO-related operations 416-426. For instance, at operation 428, a determination is made as to whether the transaction data meets initial BNPL criteria. The initial BNPL criteria may be minimum criteria that is required by all or a majority of BNPL entities for which the integration layer is in communication. For example, the BNPL criteria may be based on the transaction size, product type, merchant type, specific merchant, product location, and/or other information that is in the transaction data. For instance, all BNPL entities may require that the transaction be greater than $20. In that example, a pending purchase for a $1 pack of gum would not meet the minimum criteria. Accordingly, the determination in operation 428 may be whether the purchase data within the transaction data meets the initial BNPL criteria.

If the determination is made that the initial BNPL criteria is not satisfied, a notification that no BNPL options are available is transmitted in operation 430. The notification may be transmitted to the issuing server to notify the issuing server that the purchase cannot be completed with a BNPL option. The issuing server may then approve or deny the purchase based on other payment terms or options, such as credit or debit. The notification of no BNPL may also be transmitted to the user device and/or the terminal to notify the user that no BNPL options are available.

If, at operation 428, the transaction data does satisfy the initial BNPL criteria, the method flows to operation 432 (FIG. 4B). At operation 432, at determination is made as to whether the user is known to the BNPL entities to which the integration layer is in communication. Operation 432 may include querying the BNPL servers with the user identifying features, such as the name of the user in the payment card data of the transaction data. If the user is known to all the BNPL entities, the method 400 flows to operation 444 where a BNPL request is generated.

If, at operation 432, a determination is made that the user is not known to the BNPL servers, the method 400 flows to operation 434. At operation 434, a determination is made as to whether user data is available to the integration layer. The user data may include demographic data, historical transaction usage information, risk assessments, email address, physical address, phone number, rate of returning items, internet browsing history, past rejected transactions, or other information. The user data may be available or collected through the integration app on the user device and stored in a database of the integration layer. For instance, the user may be a frequent user of the integration app but may be a first-time user of a BNPL entity. Accordingly, a profile of the user (e.g., a collection of user data) may be created and stored based on the user data generated from use of the integration app by the user. That stored profile may then be accessed and applied when the user is purchasing items in store at a terminal.

If the user data is available and sufficient, the method 400 flows to operation 440 where a determination as to whether the user data meets user BNPL criteria is made. User data may be considered sufficient where there is enough data to compare to the user BNPL criteria. If user data is not available, or the available user data is insufficient, the method 400 flows to operation 436 where a prompt for user data is generated and transmitted for display on either the user device and/or the terminal. At operation 438, user data is received from the user device and/or the terminal. The method 400 then flows to operation 440 where a determination as to whether the user data meets the user BNPL criteria is made.

Determining whether the user data meets user BNPL criteria in operation 440 may include comparing the user data to the user BNPL criteria. The user BNPL criteria is criteria relating to the qualifications of user. The user BNPL criteria may be based on criteria from the BNPL entities. For example, some BNPL entities may not accept users that have high rate or rejected transactions or a high rate of returning items. Different BNPL entities may have different user BNPL criteria. Thus, the integration layer may aggregate or derive user BNPL criteria based on the different user BNPL criteria. Comparing the user data to the user BNPL criteria may result in the user data meeting all of the user BNPL criteria for all BNPL entities, the user data meeting user BNPL criteria for some BNPL entities, or the user data meeting no user BNPL criteria for any entity. If, at operation 440, the determination is made that the user data does not meet the user BNPL criteria for any BNPL entity, the method 400 flows to operation 442, where a notification that no BNPL options are available is generated and transmitted. Operation 442 may be substantially similar to operation 430 discussed above.

If, at operation 440, a determination is made that the user meets the user BNPL criteria for at least one BNPL entity, the method 400 proceeds to operation 444. At operation 444, a BNPL request is generated. The BNPL request may include the transaction data, or a portion thereof, that is relevant to a BNPL option. The BNPL request may also be based on or include any enrolled CLOs. An initial BNPL request may also anonymize personally identifiable information (PII) for the user so that the PII of the user is not sent to multiple BNPL entities when only one BNPL will ultimately end up funding the transaction. Rather than PII, key characteristics about the user may be included in the request, such as the non-PII user data discussed above, including whether the user has previously used any specific BNPL entities. The PII of the user (e.g., de-anonymized user data) may then later be provided to the BNPL entity that has been selected to fund the transaction.

The BNPL request may also set forth the amount of any commission that is to be provided to the BNPL entity if the BNPL entity funds the transaction. In some examples, the presence of an enrolled CLO increases the total amount of commission that may be shared with the BNPL entity. Accordingly, the enrolled CLO may reduce the total cost of purchase for the user and may also make funding the transaction more appealing to the BNPL entity due to the presence of an increased commission.

At operation 446, the BNPL request is transmitted to the BNPL servers of BNPL entities for which the user data satisfied the user BNPL criteria in operation 440. The BNPL servers then generate terms or details for funding the transaction with a BNPL option, such as interest rate, number of payments, amount per payment, late payment penalties, etc. Those details are transmitted to the integration layer and received by the integration layer in operation 448.

At operation 450, a determination is made as to whether the details for any BNPL option satisfies automatic selection criteria. The automatic selection criteria may be set by the user. For instance, the automatic selection criteria may require that the BNPL option be zero-percent interest. In that example, if a BNPL option has zero-percent interest, the BNPL option meets the automatic selection criteria. If a BNPL option received from at least one of the BNPL servers meets the automatic selection criteria in operation 450, the method 400 flows to operation 456 where a BNPL option meeting the automatic selection criteria is accepted.

If, at operation 450, a determination is made that none of the BNPL options received in operation 448 meet the automatic selection criteria (or if no automatic selection criteria is available), the method flows to operation 452, where the details for the BNPL options are transmitted for display on the user device and/or the terminal. The user may then consider the BNPL options and select one of the BNPL options. For instance, the user may select one of the options via touch screen or keypad of the user device and/or the terminal. The selection of the BNPL option is transmitted from the user device and/or the terminal back to the integration layer. The integration layer receives the selection of the BNPL option at operation 454. Then, at operation 456, the selected BNPL option is accepted. At operation 458, the acceptance of the BNPL option is transmitted to the BNPL server from which the accepted BNPL option was generated and the acceptance of the BNPL option is also transmitted to the issuing server. Transmitting the BNPL option acceptance to the BNPL server may also include transmitted PII for the user that was not previously provided to the BNPL server. At operation 460, the issuing server approves the transaction and transmits the approval through the PCN and the acquiring server to the terminal where the approval is displayed on the terminal. From the perspective of the user, the purchase may be complete and the user may leave the store with the product.

From the perspective of the other institutions and a BNPL entity, however, the method 400 continues to complete the transfer of funds for the purchase. At operation 462 (FIG. 4C), a determination is made as to whether the BNPL entity of the selected BNPL option and/or the integration layer is integrated with the merchant at the payment level, or more particularly the merchant's bank, which may be the acquiring institution. If the BNPL entity and/or the integration layer is integrated with the merchant, method 400 flows to operation 468, where funds for the purchase are transferred directly to the merchant's bank from the BNPL server. In some examples, the funds may be transferred from the BNPL entity to the issuing institution, which may then transfer the funds to the merchant. At operation 470, the purchase may then be reversed or removed from the user's credit card or debit card statement because the payment has already been fulfilled by the BNPL.

If the BNPL entity and/or the integration layer is not integrated with the merchant at the payment level, method 400 flows to operation 464 where the BNPL entity transfers funds to the user's bank account. The intent is that the user would use those funds to pay off the debit or credit charge that was used to complete the transaction. Thus, at operation 466, a charge is created on the user's payment card account. At operation 472, the BNPL entity initiates a collections process from the user to collect funds from the user according to the details of the selected BNPL offer. At operation 474, commissions and/or fees for the transaction are distributed between the CLO entity, the integration layer, and/or the BNPL entity. The commissions may be distributed according the terms set forth in the BNPL request generated in operation 444.

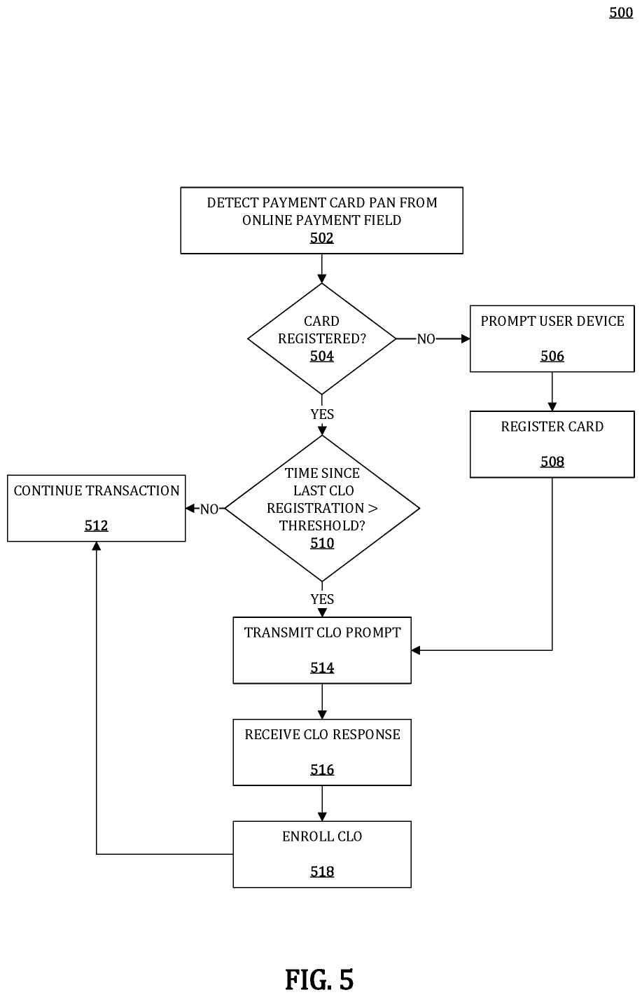

FIG. 5 depicts another example method 500 for securely completing a transaction. At operation 502, an identification number for a payment card entered into an online payment field for an online purchase is detected. For example, a user may begin the checkout process for an online purchase and enter payment card information, such as the PAN, into a payment field. The user may perform on the online purchase on a user device, such as a mobile device, tablet, laptop, desktop, or similar device. A browser extension or other integration with the payment website or app may then detect the identification number of the payment card entered into the payment field. The browser extension or app integration may be managed or controlled by the integration layer.

At operation 504, a determination is made as to whether the payment card for the detected identification number has been registered with the integration layer. If the payment card has not been registered with the integration layer, the method 500 flows to operation 506 where a user is prompted to register the card. The prompt may be generated via the browser extension or app integration. In other examples, the prompt may be generated on an integration app installed a user device, that may be the same or a different user device on which the purchase is being made. For instance, a user may be completing a purchase on a laptop, and the prompt to register the card may be presented via an integration app on the user's mobile phone. At operation 508, if the user affirmatively responds to the prompt, the payment card is registered with the integration layer. In some examples, if the user has pre-approved card registration with the integration layer, the detected payment card may be automatically registered with the integration layer without the requirement for a prompt and a response.

If, at operation 504, a determination is made that the payment card detected in operation 502 is already registered with the integration layer, the method 500 flows to operation 510. At operation 510, a determination is made as to whether a time duration since a prior CLO registration event exceeds a time threshold. For instance, when a payment card is registered with the integration layer, the integration layer may register the payment card for CLOs, as discussed further below. The integration layer may also perform CLO registration events at a regular basis or upon being notified by a CLO server that new CLOs are available. If the time duration since the last CLO registration event exceeds a time threshold, such as one or more days, weeks, or months, then additional CLOs may be available for registration. Accordingly, if the time threshold is exceeded, method 500 flows to operation 514 where a CLO registration process begins. If the time threshold is not exceeded, method 500 flows to operation 512, where the transaction or purchase is continued.

Once the payment card is registered with the integration layer at operation 510 or the time threshold is determined to be exceeded in operation 510, a CLO registration process begins. At operation 514, a CLO prompt is generated and transmitted. The CLO prompt is a prompt that is to be displayed to the user with the CLOs for which the payment card may be enrolled. The CLO prompt may be transmitted for display on the user device completing the transaction and/or an integration app on a user device. For instance, the CLO prompt may be displayed via the browser extension that detected the identification number of the payment card in operation 502.

At operation 516, a CLO response to the CLO prompt is received. The CLO response may be received as a selection of a user interface element displayed by the browser extension or by the integration app. If the CLO response is an affirmative response to enroll the payment card in the identified CLO(s), the payment card is enrolled in the identified CLO(s) at operation 518. Enrolling the payment card in the identified CLOs may include transmitting an indication of the affirmative response to the CLO server(s) that are providing the identified CLO(s). The respective CLO server(s) may then perform the enrollment of the payment card in the identified CLO(s). The CLO server(s) may also send a confirmation back to the integration layer that indicates the enrollment has completed. The method 500 then proceeds to operation 518, where the transaction continues.

The transaction continues by the user continuing to complete the checkout process for the online transaction. When the user submits the payment information for purchase, the payment card information and the purchase data (e.g., the transaction data) is processed by the merchant of the online store in a similar manner as discussed above. For instance, the transaction data is provided to the acquiring server, the PCN, and the issuing bank. The transaction data may also be provided to the integration layer and the BNPL operations 428-474 of method 400 may be performed on the received transaction data. Accordingly, with method 500, the payment card information is detected and registered for CLOs while the user is completing the transaction, and the BNPL options are completed as the transaction is being processed.

While method 500 is described above with respect an online transaction, method 500 may also be performed for an in-store transaction. For instance, as discussed above with respect to operation 404 in method 400, payment cards may be detected via a virtual wallet or other means. In such examples, when a payment card is detected, method 500 may be performed to register the payment card prior to the purchase being submitted.

The embodiments described herein may be employed using software, hardware, or a combination of software and hardware to implement and perform the systems and methods disclosed herein. Although specific devices have been recited throughout the disclosure as performing specific functions, one of skill in the art will appreciate that these devices are provided for illustrative purposes, and other devices may be employed to perform the functionality disclosed herein without departing from the scope of the disclosure. In addition, some aspects of the present disclosure are described above with reference to block diagrams and/or operational illustrations of systems and methods according to aspects of this disclosure. The functions, operations, and/or acts noted in the blocks may occur out of the order that is shown in any respective flowchart. For example, two blocks shown in succession may in fact be executed or performed substantially concurrently or in reverse order, depending on the functionality and implementation involved.

This disclosure describes some embodiments of the present technology with reference to the accompanying drawings, in which only some of the possible embodiments were shown. Other aspects may, however, be embodied in many different forms and should not be construed as limited to the embodiments set forth herein. Rather, these embodiments were provided so that this disclosure was thorough and complete and fully conveyed the scope of the possible embodiments to those skilled in the art. Further, as used herein and in the claims, the phrase “at least one of element A, element B, or element C” is intended to convey any of: element A, element B, element C, elements A and B, elements A and C, elements B and C, and elements A, B, and C. Further, one having skill in the art will understand the degree to which terms such as “about” or “substantially” convey in light of the measurement techniques utilized herein. To the extent such terms may not be clearly defined or understood by one having skill in the art, the term “about” shall mean plus or minus ten percent.

Although specific embodiments are described herein, the scope of the technology is not limited to those specific embodiments. Moreover, while different examples and embodiments may be described separately, such embodiments and examples may be combined with one another in implementing the technology described herein. One skilled in the art will recognize other embodiments or improvements that are within the scope and spirit of the present technology. Therefore, the specific structure, acts, or media are disclosed only as illustrative embodiments. The scope of the technology is defined by the following claims and any equivalents therein.

1. An integration server for securely completing a transaction, the integration server comprising:
a processor; and
memory storing instructions that, when executed by the processor, cause the integration server to perform a set of operations comprising:
receiving transaction data for a pending purchase by a user, the transaction data including payment card data and purchase data, wherein the payment card data was received by a terminal and the transaction data has been transmitted through an acquiring server, a payment card network (PCN), and an issuing server;
based on receiving the transaction data, determining that a card-linked offer (CLO) is available for the transaction data;
transmitting a CLO prompt to at least one of the terminal or a user device;
receiving a CLO response to the CLO prompt;
based on receiving the CLO response, transmitting a notification to enroll a payment card indicated in the payment card data in the CLO;
determining that the purchase data satisfies initial buy now, pay later (BNPL) criteria;
based on the determination that the transaction data satisfies the initial BNPL criteria, identifying user data for the user;
determining that the user data satisfies user BNPL criteria;
based on determining that the user data satisfies the user BNPL criteria, transmitting anonymized transaction data to a plurality of BNPL servers, including a first BNPL server and a second BNPL server;
receiving details for a plurality of BNPL options from the BNPL servers, including a first BNPL option from the first BNPL server and a second BNPL option from the second BNPL server;
transmitting the details for the plurality of BNPL options to at least one of the terminal or the user device;
receiving a selection of the first BNPL option; and
transmitting a BNPL acceptance notification indicating acceptance of the first BNPL option to the issuing server and the first BNPL server, wherein the BNPL acceptance notification transmitted to the first BNPL server includes deanonymized user data.

2. The integration server of claim 1, wherein the transaction data has been verified by the acquiring server and validated by the issuing server.

3. The integration server of claim 1, wherein the CLO prompt is transmitted to the user device via an Internet connection and does not pass through the PCN.

4. The integration server of claim 1, wherein the CLO prompt is transmitted to the terminal via the issuing server, the PCN, and the acquiring server.

5. The integration server of claim 1, wherein the initial BNPL criteria include a minimum purchase price.

6. The integration server of claim 1, wherein the user data is generated from interactions of the user with an integration app installed on the user device, wherein the integration app is managed by the integration server.

7. The integration server of claim 6, wherein the user data includes at least one of historical transaction usage information, a rate of returning items, internet browsing history, or past rejected transactions.

8. The integration server of claim 7, further comprising displaying the details for the plurality of BNPL options via the integration app.

9. A method for securely completing a transaction, the method performed by an integration layer and the method comprising:
receiving transaction data for a pending purchase by a user, the transaction data including payment card data and purchase data, wherein the transaction data has been transmitted through an acquiring server, a payment card network (PCN), and an issuing server;
based on receiving the transaction data, determining that a card-linked offer (CLO) is available for the transaction data;
transmitting a notification to enroll a payment card indicated in the payment card data in the CLO;
identifying user data for the user, wherein the user data is generated from interactions of the user with an integration app installed on a user device, wherein the integration app is managed by the integration layer;
determining that the user data satisfies user BNPL criteria;
based on determining that the user data satisfies the user BNPL criteria, transmitting anonymized transaction data to one or more BNPL servers;
receiving details for a plurality of BNPL options from the one or more BNPL servers;
based on the received details, accepting one of the BNPL options in the plurality of BNPL options; and
transmitting a BNPL acceptance notification indicating acceptance of the accepted BNPL option to the issuing server and one of the one or more BNPL servers, wherein the BNPL acceptance notification transmitted to the BNPL server includes deanonymized user data.

10. The method of claim 9, wherein the transaction data has been verified by the acquiring server and validated by the issuing server.

11. The method of claim 9, wherein the payment card data was received by a terminal.

12. The method of claim 9, wherein the CLO prompt is transmitted to the user device via an Internet connection and does not pass through the PCN.

13. The method of claim 12, further comprising displaying the CLO prompt via the integration app.

14. The method of claim 9, wherein the CLO prompt is transmitted to a terminal via the issuing server, the PCN, and the acquiring server.

15. The method of claim 9, wherein the user data includes at least one of historical transaction usage information, a rate of returning items, internet browsing history, or past rejected transactions.

16. A system comprising:
a terminal configured to read payment card data from a physical payment card, the terminal in communication with an acquiring server that is in communication with a payment card network (PCN); and
an integration server in communication with a plurality of BNPL servers and an issuing server that is in communication with the PCN, the integration server comprising:
a processor; and
memory storing instructions that, when executed by the processor, cause the integration server to perform a set of operations comprising:
receiving, from the issuing server, transaction data for a pending purchase by a user, the transaction data including purchase data and payment card data from a physical payment card read by the terminal, wherein the transaction data has been transmitted through the acquiring server, the PCN, and the issuing server;
transmitting anonymized transaction data to the plurality of BNPL servers, including a first BNPL server and a second BNPL server;
receiving details for a plurality of BNPL options from the plurality of BNPL servers, including a first BNPL option from the first BNPL server and a second BNPL option from the second BNPL server;
transmitting the details for the plurality of BNPL options to the terminal for display on the terminal;
receiving, from the terminal, a selection of the first BNPL option; and
transmitting a BNPL acceptance notification indicating acceptance of the first BNPL option to the issuing server and the first BNPL server, wherein the BNPL acceptance notification transmitted to the first BNPL server includes deanonymized user data.

17. The system of claim 16, wherein the details for the plurality of BNPL options are transmitted to the terminal via the issuing server, the PCN, and the acquiring server.

18. The system of claim 16, wherein the selection of the first BNPL option is received from the terminal via the acquiring server, the PCN, and the issuing server.

19. The system of claim 16, wherein the set of operations further comprise:
identifying user data for the user; and
determining that the user data satisfies user BNPL criteria.

20. The system of claim 19, wherein the user data is generated from interactions of the user with an integration app installed on a user device, wherein the integration app is managed by the integration server.

21-28. (canceled)
